(19) United States
(12) Patent Application Publication
(10) Pub. No.: US 2026/0323557 A1
(43) Pub. Date: Oct. 15, 2026

(54) ENHANCED ACCESS FOR FIXED WIRELESS ACCESS USER EQUIPMENT

(71) Applicant: QUALCOMM Incorporated, San Diego, CA (US)

(72) Inventors: Yan ZHOU, San Diego, CA (US); Kiran VENUGOPAL, Green Brook, NJ (US); Jing JIANG, San Diego, CA (US)

(21) Appl. No.: 19/642,178

(22) Filed: Apr. 8, 2026

Related U.S. Application Data
(60) Provisional application No. 63/787,594, filed on Apr. 11, 2025.

(51) Int. Cl. H04W 56/00; H04W 74/08

(52) U.S. Cl. CPC H04W 56/0045; H04W 74/08

(57) ABSTRACT

Various aspects of the present disclosure generally relate to wireless communication. In some aspects, an fixed wireless access (FWA) user equipment (UE) may transmit, using stored timing advance information, a msg3 associated with configured-grant-based access after a msg1 and a msg2 is skipped. The FWA UE may receive a message in response to the msg3. Numerous other aspects are described.

### CROSS-REFERENCE TO RELATED APPLICATION

This Patent Application claims priority to U.S. Provisional Patent Application No. 63/787,594, filed on Apr. 11, 2025, entitled “ENHANCED ACCESS FOR FIXED WIRELESS ACCESS USER EQUIPMENT,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with enhanced early access for a fixed wireless access user equipment.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a fixed wireless access (FWA) user equipment (UE). The method may include transmitting, using stored timing advance (TA) information, a msg3 associated with configured grant (CG)-based access after a msg1 and a msg2 is skipped. The method may include receiving a message in response to the msg3.

Some aspects described herein relate to a method of wireless communication performed by a UE. The method may include receiving a configuration for a CG-based access that is specific to an FWA UE or a non-FWA UE. The method may include transmitting, using stored TA information, a msg3 associated with the CG-based access after a msg1 and a msg2 is skipped.

Some aspects described herein relate to an FWA UE. The fixed wireless access may include a processing system. The processing system may include one or more processors and one or more code-storing memories coupled with the one or more processors. The processing system may be configured to cause the FWA UE to transmit, using stored TA information, a msg3 associated with CG-based access after a msg1 and a msg2 is skipped. The processing system may be configured to cause the FWA UE to receive a message in response to the msg3.

Some aspects described herein relate to a UE. The UE may include a processing system. The processing system may include one or more processors and one or more code-storing memories coupled with the one or more processors. The processing system may be configured to cause the UE to receive a configuration for a CG-based access that is specific to an FWA UE or a non-FWA UE. The processing system may be configured to cause the UE to transmit, using stored TA information, a msg3 associated with the CG-based access after a msg1 and a msg2 is skipped.

Some aspects described herein relate to a non-transitory computer-readable medium that stores a set of instructions for wireless communication by an one or more instructions that, when executed by one or more processors of an FWA UE. The set of instructions, when executed by one or more processors of the one or more instructions that, when executed by one or more processors of an FWA UE, may cause the one or more instructions that, when executed by one or more processors of an FWA UE to transmit, using stored TA information, a msg3 associated with CG-based access after a msg1 and a msg2 is skipped. The set of instructions, when executed by one or more processors of the one or more instructions that, when executed by one or more processors of an FWA UE, may cause the one or more instructions that, when executed by one or more processors of an FWA UE to receive a message in response to the msg3.

Some aspects described herein relate to a non-transitory computer-readable medium that stores a set of instructions for wireless communication by a UE. The set of instructions, when executed by one or more processors of the UE, may cause the UE to receive a configuration for a CG-based access that is specific to an FWA UE or a non-FWA UE. The set of instructions, when executed by one or more processors of the UE, may cause the UE to transmit, using stored TA information, a msg3 associated with the CG-based access after a msg1 and a msg2 is skipped.

Some aspects described herein relate to an apparatus for wireless communication. The apparatus may include means for transmitting, using stored TA information, a msg3 associated with CG-based access after a msg1 and a msg2 is skipped. The apparatus may include means for receiving a message in response to the msg3.

Some aspects described herein relate to an apparatus for wireless communication. The apparatus may include means for receiving a configuration for a CG-based access that is specific to an FWA UE or a non-FWA UE. The apparatus may include means for transmitting, using stored TA information, a msg3 associated with the CG-based access after a msg1 and a msg2 is skipped.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example of access messages that can be skipped.

FIG. 3 is a diagram illustrating examples of updating a timing advance.

FIG. 4 is a diagram illustrating an example of configured grant (CG)-based access.

FIG. 5 is a diagram illustrating an example of an access procedure that skips messages.

FIG. 6 is a diagram illustrating an example of CG resources.

FIG. 7 is a diagram illustrating an example process performed, for example, at a fixed wireless access (FWA) user equipment (UE) or an apparatus of an FWA UE.

FIG. 8 is a diagram illustrating an example process performed, for example, at a UE or an apparatus of a UE.

FIG. 9 is a diagram of an example apparatus for wireless communication.

FIG. 10 is a diagram of an example apparatus for wireless communication.

### DETAILED DESCRIPTION

Timing advance (TA) is a mechanism used in wireless communication systems to synchronize the transmission timing of user equipment (UE) with a network (e.g., base station), ensuring that signals from the UE arrive at the base station correctly aligned in time. This synchronization compensates for the travel time of the signal, which helps the network maintain efficient and reliable communication. The network may update the UE with a new TA. TA updates maintain effective communication between the UE and the base station.

Fixed wireless access (FWA) UEs typically exhibit semi-static or fixed location behavior, such as customer premises equipment (CPE) placed on a table or mounted on a rooftop. Due to the relatively stationary nature of FWA UEs, many communication parameters, such as TA to a given cell, may remain constant for extended periods provided the UE remains at the same location.

Current systems typically rely on timer-based TA validation and update mechanisms, which may trigger a TA update regularly, regardless of whether any significant changes in the UE's environment or location have occurred. This approach can lead to unnecessary signaling overhead and potential service interruptions, particularly for FWA UEs whose environmental conditions change infrequently. Furthermore, the random access channel (RACH) procedure used for initial access involves multiple message exchanges, including messages for TA acquisition, which can add latency to the initial access process.

Furthermore, TA update schemes may not account for the various states of the UE (idle, inactive, or connected) and provide flexibility to trigger TA updates based on significant environmental changes. Moreover, there is no validation of the TA's current status or conditions for restricting UE-initiated TA to mitigate excessive TA updates that avoid network congestion.

Various aspects relate generally to enhancing initial access procedures for FWA UEs. Some aspects more specifically relate to the FWA UE transmitting a msg3 associated with configured grant (CG)-based access utilizing stored TA information, after skipping msg1 and msg2. The FWA UE may then receive a response message to the msg3, such as a msg4. In some aspects, the FWA UE may determine whether to use a timer-based TA update scheme or an environment-based TA update scheme for a cell based on its long-term mobility type information. This determination may be made autonomously by the UE or based on configurations provided by the network. Furthermore, the FWA UE may detect environmental changes based on signal measurements, location, orientation, or downlink timing and initiate a TA update accordingly. The FWA UE may calculate an updated TA based on the timing difference between a first cell and a reference cell, as well as a known TA value for the reference cell when initiating the TA update. In addition, the FWA UE may receive an indication of a TA update scheme preference, start a timer after a TA update completion to determine TA validity, and adhere to conditions that restrict initiating new TA updates for a specified duration.

Particular aspects of the subject matter described in this disclosure can be implemented to realize one or more of the following potential technical advantages. By employing a method where the FWA UE uses stored TA information to transmit a msg3 associated with CG-based access after skipping msg1 and msg2, the described techniques can be used to reduce signaling overhead in the network infrastructure. This efficient use of signaling resources may lead to a more streamlined network operation, conserving processing and network resources. In some aspects, by enabling FWA UEs to determine the appropriate TA update scheme based on their mobility type or environmental changes, the techniques provide a flexible approach to maintaining accurate TA while minimizing unnecessary updates. This targeted application of TA updates conserves processing resources and battery life in the UE and reduces the signaling burden on the network.

In some aspects, the FWA UE may streamline the access procedure through the use of CG-based access and the potential for direct registration requests. As a result, the FWA UE can achieve faster connectivity with reduced setup time. This enhancement leads to quicker network resource allocation and can improve network efficiency by reducing the time and processing resources required to establish connections with semi-static FWA UEs.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

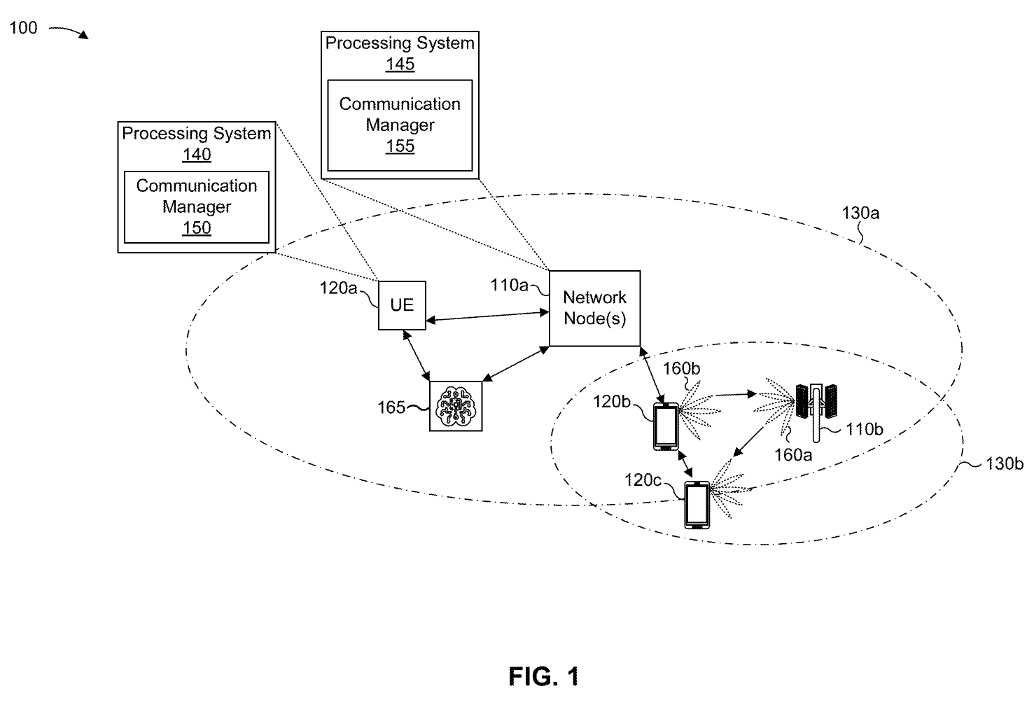

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a CQI (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a(for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, an FWA UE (e.g., a UE 120) may include a communication manager 150. As described in more detail elsewhere herein, the communication manager 150 may transmit, using stored TA information, a msg3 associated with CG-based access after a msg1 and a msg2 is skipped; and receive a message in response to the msg3. Additionally, or alternatively, the communication manager 150 may perform one or more other operations described herein.

In some aspects, the UE 120 may include a communication manager 150. As described in more detail elsewhere herein, the communication manager 150 may receive a configuration for a CG-based access that is specific to an FWA UE or a non-FWA UE; and transmit, using stored TA information, a msg3 associated with the CG-based access after a msg1 and a msg2 is skipped. Additionally, or alternatively, the communication manager 150 may perform one or more other operations described herein.

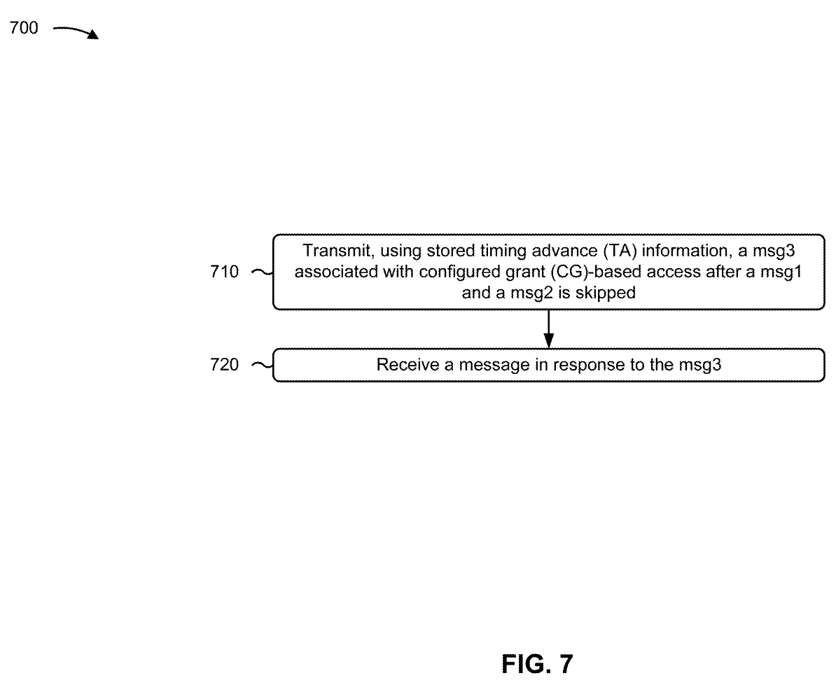

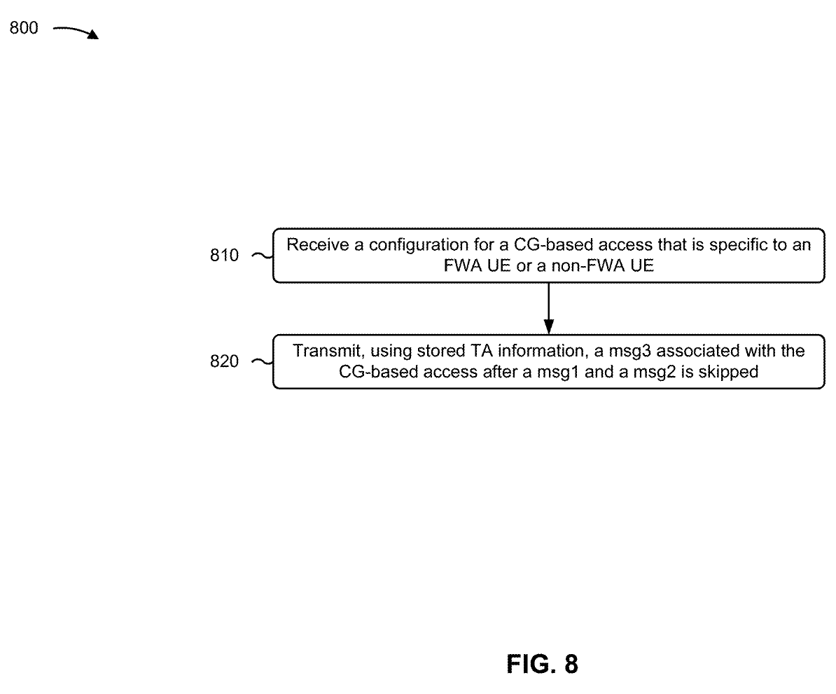

The network node 110, the processing system 145 of the network node 110, the UE 120, the processing system 140 of the UE 120, or any other component(s) of FIG. 1 may implement one or more techniques or perform one or more operations associated with enhanced access for FWA UEs, as described in more detail elsewhere herein. For example, the processing system 145 of the network node 110, or the processing system 140 of the UE 120 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 700 of FIG. 7, process 800 of FIG. 8, or other processes as described herein. In some examples, executing instructions may include running the instructions, converting the instructions, compiling the instructions, or interpreting the instructions, among other examples.

Due to the relatively stationary nature of an FWA UE, many communication parameters may remain constant for a long time. For example, the TA to a given cell may remain the same if the FWA UE stays at the same location. The set of reachable cells may remain the same if the FWA UE stays at the same location. Therefore, the initial access procedure can be simplified by taking advantage of those constant parameters.

In some aspects, an FWA UE (e.g., a UE 120) includes means for transmitting, using stored TA information, a msg3 associated with CG-based access after a msg1 and a msg2 is skipped; or means for receiving a message in response to the msg3.

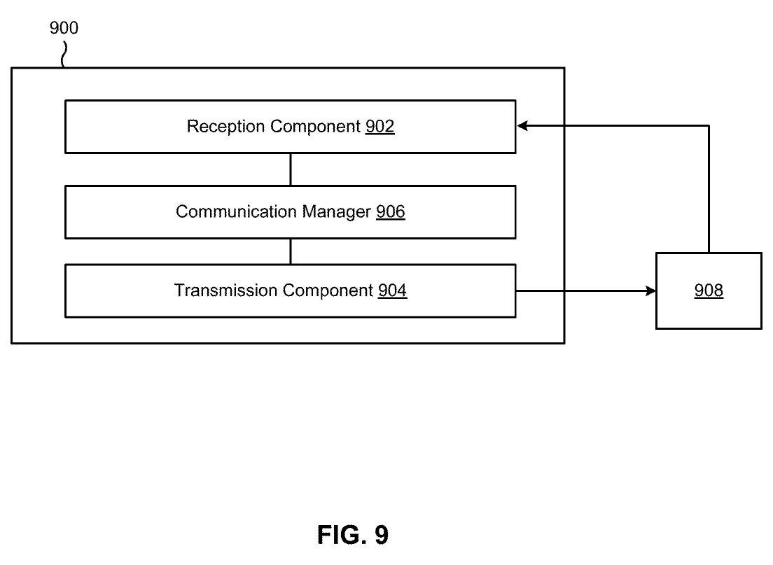

In some aspects, a UE (e.g., a UE 120) includes means for receiving a configuration for a CG-based access that is specific to an FWA UE or a non-FWA UE; or means for transmitting, using stored TA information, a msg3 associated with the CG-based access after a msg1 and a msg2 is skipped. The means for the UE to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

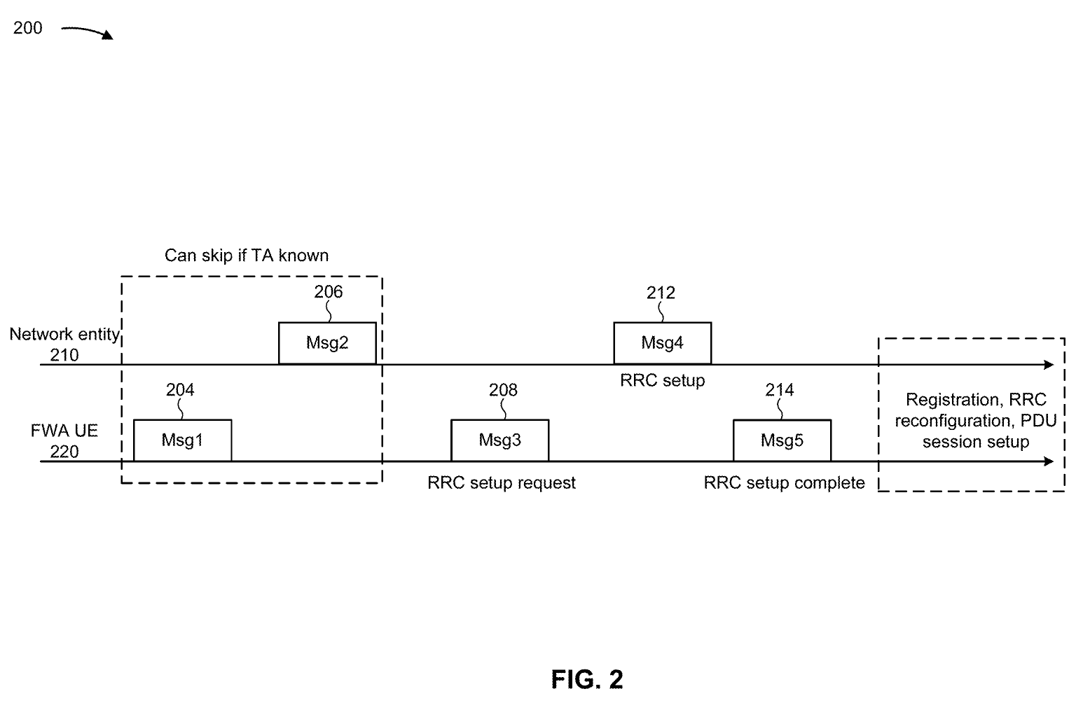

FIG. 2 is a diagram illustrating an example 200 of access messages that can be skipped.

In the context of wireless communication, particularly in the initial access procedure for a UE, the messages msg1, msg2, msg3, msg4, and msg5 are part of an access procedure. For example, as part of an initial access procedure (e.g., RACH procedure), msg1 is an initial random access preamble sent by the UE to the network and is used to initiate the random access procedure and request access to the network. Msg2 is the response (e.g., a random access response (RAR)) sent by the network in response to msg1. Msg2 includes information such as timing advance, uplink resource grants, and a temporary identifier for the UE. Msg3 is sent by the UE using the resources allocated in msg2. Msg3 may include an RRC connection request, which includes the UE's identity and other necessary information for establishing a connection. Msg4 is the RRC connection setup message sent by the network in response to msg3. Msg4 includes the configuration details needed for the UE to establish and maintain a connection with the network. Msg5 is sent by the UE to complete the RRC connection setup. Msg5 includes an RRC connection setup complete message, which confirms the successful establishment of the connection and may include additional registration and configuration information.

CG access is a mechanism used in wireless communication systems, particularly in 5G NR, to allow a UE to transmit data without the need for dynamic scheduling by the network for each transmission. This approach is designed to reduce latency and signaling overhead, making it particularly useful for applications requiring low-latency communication, such as URLLC and certain IoT use cases.

In a typical dynamic scheduling scenario, the UE must request resources from the network each time the UE needs to transmit data, and the network must respond with a grant specifying the resources (such as time, frequency, and power) that the UE can use. This process involves multiple signaling exchanges, which can introduce latency.

CG-based access simplifies access by pre-allocating resources to the UE. The network configures the UE with specific parameters that define when and how the UE can transmit data. CG-based access is particularly beneficial for FWA user equipment, which typically has a stable and predictable communication pattern due to its fixed or semi-static location. This allows the network to optimize resource allocation and improve overall communication efficiency.

The CG-based access is associated with various scenarios, including initial access, RRC setup for an idle UE, RRC resume for an inactive UE transitioning to RRC connected mode, small data transmission for UE staying in inactive mode, beam failure detection or radio link failure for a connected UE failure recovery, a scheduling request, a buffer status report, or an event-triggered report. These associations underscore the versatility and breadth of CG-based access in facilitating efficient and rapid communication setup for FWA UE 220.

Example 200 shows a sequence of messages that may be transmitted and received during an initial access procedure for an FWA UE 220 (e.g., UE 120), which may be a CG-based access. Example 200 shows a msg1 204 from the FWA UE 220 that can be skipped if TA information is known by the FWA UE 220. The msg1 204 is followed by a msg2 206 from a network entity 210 (e.g., network node 110) that can also be skipped under the same condition. Subsequently, a msg3 208 associated with CG-based access is transmitted by the UE 220. Following msg3 208, a msg4 212 is depicted which represents an RRC setup message, and a msg5 214 represents a registration, RRC reconfiguration, and RRC connection session setup message.

The FWA UE 220 may only require occasional updates to the TA if there are significant environmental changes, such as variations in received signal strength, location, orientation, or other environmental factors.

According to various aspects described herein, the FWA UE 220 may transmit msg3 208 using stored TA information that would have otherwise been provided in msg2 206. Accordingly, the FWA UE 220 may skip transmission of msg1 204, and the network entity 210 may skip transmission of msg2 206. That is, the FWA UE 220 may proceed directly with the msg3 as a first message of the CG-based access. This approach effectively reduces the latency involved in the initial access procedure by leveraging the fact that the TA for FWA UE 220 is relatively stable due to its fixed or semi-static nature. Msg4 212 or msg5 214, in response to msg3 208, may aid in completing the RRC setup or registration process.

A timer-based TA update scheme involves updating the TA at regular intervals, regardless of whether there have been any significant changes in the UE's environment or location. This approach ensures that the TA remains accurate over time but may lead to unnecessary signaling overhead if the UE's position is stable. This scheme is suitable for scenarios where the FWA UE's environment is expected to change periodically, even if the UE itself is stationary. For example, changes in signal reflections or obstructions might occur over time, affecting the TA.

Mode 1 of the timer-based TA update may be network-initiated and triggered if a TA timer expires since the last update. This mode is mainly for connected UEs. In some aspects, mode 2 is UE-initiated, where the UE autonomously initiates or triggers the TA update if the TA timer expires since the last update. This mode can be applicable to all UE RRC states, including idle, inactive (e.g., for early TA acquisition before initial access).

An environment-based TA update scheme triggers TA updates based on detected changes in the UE's environment. This could include variations in signal measurements, changes in the UE's location or orientation, or other environmental factors that impact the TA. This scheme is ideal for FWA UEs that are generally stationary but might experience occasional environmental changes that affect their communication parameters. By detecting these changes and updating the TA accordingly, the network entity 210 can maintain efficient and reliable communication without unnecessary updates. In addition, the method includes receiving a configuration for the timer-based TA update scheme and a configuration for the environment-based TA update scheme.

Mode 1 of the environment-based scheme may be network-initiated, and the FWA UE 220 may be configured to report a location or RF change (e.g. via PDCCH order). This mode is mainly for a connected UE. In some aspects, mode 2 is UE-initiated, where the FWA UE 220 autonomously initiates or triggers the TA update if the location or RF changes significantly. This mode can be applicable to all UE RRC states, including idle, inactive (e.g., for early TA acquisition before initial access).

To determine the TA update scheme, the network entity 210 may collect data on the FWA UE's mobility patterns, including its location stability, signal measurements, and environmental factors. The network entity 210 may analyze the collected data to determine whether the UE exhibits long-term stability or experiences periodic environmental changes. Based on the analysis, the network entity 210 may determine whether to use the timer-based TA update scheme or the environment-based TA update scheme for the FWA UE 220. The network entity 210 may indicate the TA update scheme to the FWA UE 220. By selecting the appropriate TA update scheme, the network entity 210 can reduce signaling overhead and conserve resources. Ensuring accurate TA updates based on the FWA UE' 220s mobility behavior helps maintain efficient and reliable communication. The ability to switch between timer-based and environment-based schemes allows the network entity 210 to adapt to different mobility scenarios.

In some aspects, the FWA UE 220 may determine whether to use the timer-based TA update scheme or the environment-based TA update scheme for a cell based on long-term mobility type information of the FWA UE 220, which may include data or parameters that characterize the mobility behavior of an FWA UE over an extended period. This information is used to determine the appropriate TA update scheme for the FWA UE. Long-term mobility type information may indicate the movement patterns and stability of the FWA UE over a prolonged duration. This information helps in understanding whether the UE remains stationary, moves infrequently, or experiences significant environmental changes that could affect its communication parameters.

In some aspects, the FWA UE 220 may detect an environmental change based on at least one of a signal measurement, a location of FWA UE 220, an orientation of FWA UE 220, or a downlink timing. In response to detecting an environmental change that satisfies a predefined threshold, the FWA UE 220 may initiate the TA update using a TA update scheme that is appropriate for the detected environmental change.

The FWA UE 220 may calculate an updated TA based at least in part on a received timing difference between a first cell and a reference cell, as well as a known TA value for the reference cell. The FWA UE 220 may start a timer after completion of the TA update, where the updated TA remains valid until the timer expires. The FWA UE 220 may receive one or more conditions that restrict the FWA UE 220 from initiating a new TA update for a specified duration.

As shown by example 200, the FWA UE 220 may transmit themsg3 208. The FWA UE 220 may use stored TA information for the transmission, without relying on obtaining TA information from msg2 206. The FWA UE 220 may also use a TA update scheme to update the TA information and transmit future messages using the updated TA information.

The FWA UE 220 may receive a message with a CG radio network temporary identifier (RNTI) for scheduling a msg3 208 retransmission associated with skipping msg1 204 and msg2 206. Moreover, the FWA UE 220 may be preconfigured with a TA validity condition that determines when an updated TA remains valid based on the recurrence of one or more configured events.

In some aspects, the FWA UE 220 may have multiple options for updating the TA. In a first option, the FWA UE 220 may update the TA based at least in part on long-term mobility type information. The long-term mobility type can be classified into three categories: mobile (UE frequently changes its location), semi-static (UE has limited movement, such as a CPE placed on a table), or a fixed location (UE remains stationary, such as a CPE mounted on a rooftop). As a basic rule, mobile UEs may use a timer-based TA update, while semi-static and fixed location UEs may use an environment-based TA update.

In the case of a TA update for a connected UE, the UE’s long-term mobility type information can be communicated via UCI, a MAC-CE, or RRC messages, such as a UE capability indication or UE assistance information (UAI). The network entity 210 may select either the timer-based or environment-based TA update based on the UE’s long-term mobility type information.

In the case of a TA update for an idle or inactive UE, a first sub-option may be that the network entity 210 (e.g., cell) broadcasts configurations for both timer-based and environment-based UE-initiated TA updates. The FWA UE 220 may select the appropriate configuration based at least in part on its long-term mobility type. A second sub-option may be that the FWA UE 220’s long-term mobility type information may be communicated during a previous connection with the same cell. Based on this information, the cell may configure either a timer-based or environment-based UE-initiated TA update for when the FWA UE 220 is later in an idle or inactive state.

As a second option, the FWA UE 220 may implicitly determine which TA update scheme to use if certain condition(s) are satisfied, which can be configured by the network entity 210 or a specification (stored configuration information). For example, the FWA UE 220 may use the environment-based TA update if the following sub-options are satisfied. A default scheme can be used at least when the condition evaluation is not available (e.g., timer-based TA update). As a first sub-option, the FWA UE 220 may use the environment-based TA update based at least in part on statistics of cell switch number or count in the last X ms is below a threshold in idle, inactive, and/or connected modes.

As a second sub-option, the FWA UE 220 may use the environment-based TA update based at least in part on the statistics of cell quality and/or downlink timing variation in the last X ms is less than the corresponding threshold(s) for some cell(s) or cell pair(s) in a set of N measured cell(s) or cell pair(s). The variation can be computed as a cell metric variation across time for each individual cell or computed as the variation of cell metric difference across time for a given cell pair. The above some cell(s) can be at least Y cell(s) or cell pair(s) in the set of N measured cell(s) or cell pair(s), where Y is from 1 to N, and can be indicated by the network entity 210 or obtained from stored configuration information (specification). The above cell quality can be an RSRP, a signal-to-interference-plus-noise ratio (SINR), or an RSRQ.

As a third sub-option, the FWA UE 220 may use the environment-based TA update based at least in part on the statistics of a UE location and/or orientation variation in the last X ms is less than the corresponding threshold(s). For all options, the statistics may include the mean, a variance, or a percentile.

As a third option for selecting a TA update scheme, the FWA UE 220 may explicitly indicates its preference for the TA update scheme. For example, the FWA UE 220 may indicate that an environment-based TA update is preferred in UAI. In the case of a connected UE, the network entity 210 may select the TA update scheme based at least in part on the UE’s preference. In the case of an idle or inactive UE, the FWA UE 220’s preference may be signaled in a previous connection with the network entity 210. Based on the preference, the network entity 210 may configure either the timer-based TA update scheme or the environment-based UE-initiated TA update scheme when the UE later is in idle or inactive state.

A fourth option for selecting a TA update scheme may be similar to the first option, except that the network entity 210 identifies the UE long-term mobility type based on the network entity 210’s implementation. The network entity 210 may select the timer-based TA update scheme or the environment-based TA update scheme based at least in part on the identified UE long-term mobility type. For example, the network entity 210 may, based at least in part on the RSRP or location report, determine whether the FWA UE 220 is semi-static and then configure the environment-based TA update scheme for the FWA UE 220.

In some aspects, the network entity 210 may configure the FWA UE 220 with conditions for triggering a TA update. As a first option that is RF-based, the FWA UE 220 may initiate a TA update if the cell quality change for each cell or cell quality difference for any two cells is greater than a threshold for some cell(s) in a set of N measured cell(s). As a second option that is location-based, the FWA UE 220 may initiate the TA update if a location change is greater than a threshold. As a third option that is orientation-based, the FWA UE 220 may initiate the TA update if its orientation change is greater than a threshold. As a fourth option, the FWA UE 220 may initiate the TA update if its DL timing change is greater than a threshold.

As a fifth option that is RF-based, the FWA UE 220 may initiate the TA update if a cell quality change for each cell or a cell quality difference for any two cells is greater than a threshold for some cell(s) in a set of N measured cell(s), where cell quality can be RSRP, SINR, or RSRQ. The set of measured cell(s) can only include the cell for TA update, or can be configured by the network entity 210. Some cell(s) whose RSRP change exceeds a threshold can be at least X cell(s) in the set of N measured cell(s), where X is from 1 to N, and can be indicated by the network entity 210 or a specification. The cell quality definition may be similar to that for RRM measurement. For example, the FWA UE 220 may select the highest measured beam quality of that cell if the highest measured beam quality is not above a threshold. Otherwise, the cell quality is the average of the top Y measured beam qualities above a threshold. The threshold and Y can be provided by the network entity 210 or a specification. The cell quality change is computed as the absolute difference between the current cell quality and a previous reference cell quality. The previous reference cell quality can be determined when the FWA UE 220 receives the TA update configuration, or when the FWA UE 220 initiates the TA update (or receives the TA command), whichever is the latest.

As a sixth option that is location-based, the FWA UE 220 may initiate a TA update if its location change is greater than a threshold. The location change may be computed as the distance between the current UE location and a reference location. The reference location can be a fixed location, whose coordinates can be provided by network entity 210 (e.g., the location of the cell for the TA update). The reference location may be a previous UE reference location, which can be determined when t the FWA UE 220 receives the TA update configuration, or when the FWA UE 220 initiates the TA update (or receives the TA command), whichever is later.

As a seventh option that is orientation-based, the FWA UE 220 may initiate a TA update if its orientation change is greater than a threshold. The orientation change is computed as the angle between the current UE orientation and a reference orientation. The reference orientation may be a fixed orientation, whose direction can be provided by the network entity 210. The reference orientation may be a previous UE reference orientation, which can be determined when the FWA UE 220 receives the TA update configuration, or when UE initiates the TA update (or receives the TA command), whichever is the latest.

As an eighth option that is DL-timing-based, the FWA UE 220 may initiate a TA update if its DL timing change is greater than a threshold. The same sub-options described for the fifth option may be applied after replacing a cell quality by a cell DL timing.

Multiple options can be used jointly, and the TA update may be triggered if conditions are satisfied for at least X options of a total N used options, where X is from 1 to N, and can be indicated by the network entity 210 or a specification. For each option, the network entity 210 or the specification may indicate a time duration to trigger, and the corresponding condition may be satisfied for such a duration to trigger the TA update. For each option, the network entity 210 or the specification may indicate a TA update forbidden timer, which starts after each triggered TA update. No new TA update can be triggered while the timer is running.

As indicated above, FIG. 2 is provided as an example. Other examples may differ from what is described with regard to FIG. 2.

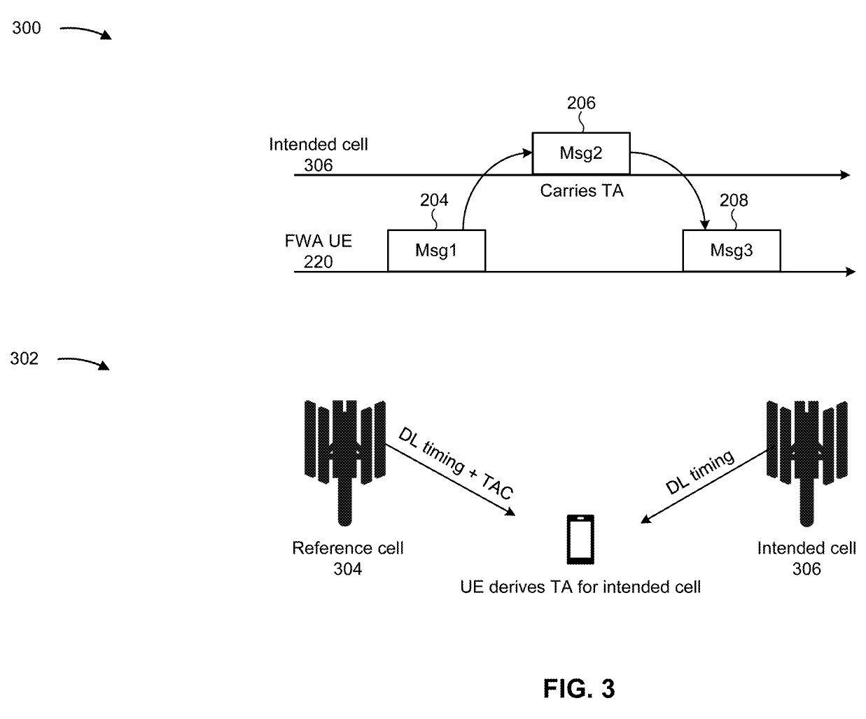

FIG. 3 is a diagram illustrating examples 300 and 302 of updating a TA.

Example 300 shows a RACH-based TA update. The FWA UE 220 may transmit a PRACH in msg1 204, and the intended cell 306 may respond with msg2 204, which includes the updated TA. Msg3 208 may be scheduled by msg2 204 to acknowledge the TA command, and may carry the PRACH purpose and a UE identifier (ID). The preamble and/or RACH occasion (RO) may be reserved for the TA update purpose only, especially when msg3 206 is not scheduled. The FWA UE 220 may be in any RRC state, including idle, inactive, or connected.

Example 302 shows a UE-based TA update. The FWA UE 220 may derive an updated TA for the intended cell 306 based on a receive timing difference between the intended cell 306 and a reference cell 304 (e.g., an anchor cell), as well as a TA value for the reference cell 304. This requires the FWA UE 220 to know the TA for the reference cell 304. The network entity 210 may indicate IDs (e.g., physical cell ID (PCIs)) of the reference cell 304 and the intended cell 306.

In some aspects, after completion of each UE-initiated TA update, the network entity 210 (or a specification) may indicate a TA validity condition for the FWA UE 220 to determine when the updated TA is still valid. In one option, a timer may be started after the completion, and the TA is valid until the timer expires. This option may be more suitable for timer-based UE-initiated TA updates. As another option, the TA may be valid until a certain event is triggered (e.g., event defined earlier). This option may be more suitable for environment-based UE-initiated TA updates.

In some aspects, the network entity 210 (or a specification) may indicate a certain condition to forbid UE-initiated TA updates (e.g., to reduce the PRACH load). As a first option, the timer may start after the completion, and the FWA UE 220 may not initiate a new TA update before the timer expires. As a second option, the FWA UE 220 may not initiate a new TA update if at least X TA updates have been initiated within a previous time window with duration of Y ms, where X and Y can be provided by the network entity 210 or a specification. As a third option, the network entity 210 may dynamically enable/disable the UE-initiated TA (e.g., via broadcast or dedicated RRC, MAC-CE, and DCI).

In some aspects, instead of CG-based access, the FWA UE 220 may fall back to a default random access scheme if the TA is invalid but TA update is forbidden. The default random access may be RACH-based (e.g., 4-step RACH or 2-step RACH).

As shown in example 200 of FIG. 2, with a known TA, RACH-based initial access can be simplified to CG-based initial access (e.g., directly starting from msg3 208 in 4-step RACH). For RRC setup, an idle UE can directly send msg3 208 within RRC setup request in CG, and msg4 212 may include an RRC setup configuration. For RRC resume, an inactive UE may directly transmit msg3 208 with an RRC resume request in CG, and msg4 212 may include an RRC resume configuration. In the case of contention-based CG shared with other UEs, msg3 208 may also carry a UE contention resolution ID. The network entity 210 (or a specification) may indicate whether msg3 208 is to carry a UE contention resolution ID (e.g., in a SIB, a dedicated RRC, or implied by the CG resource type, such as a shared or dedicated CG).

In some scenarios of RACH-based initial access, the FWA UE 220 may monitor for msg2 PDCCH with a random access RNTI (RA-RNTI), and a temporary cell RNTI (TC-RNTI) in msg2 206 may be used for scheduling a msg3 retransmission and msg4 initial transmission and retransmission, and will become a cell RNTI (C-RNTI) after contention resolution in msg4 212.

However, in some aspects of CG-based access, msg1 204 and msg2 206 may be skipped. It has not been specified as to which RNTI is to schedule msg3 retransmissions and msg4initial transmissions and retransmissions, or how TC-RNTI is signaled.

As indicated above, FIG. 3 is provided as an example. Other examples may differ from what is described with regard to FIG. 3.

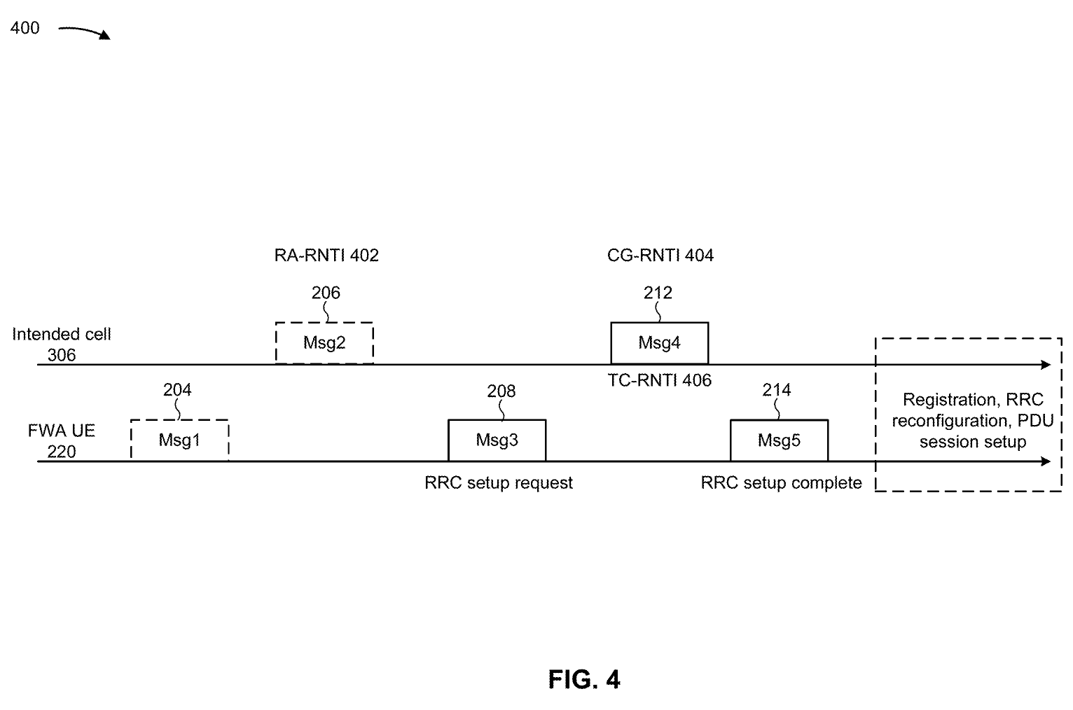

FIG. 4 is a diagram illustrating an example 400 of CG-based access. In the case of CG-based initial access, the network entity 210 may introduce a separate RNTI (e.g., CG-RNTI 404) for scheduling msg3 retransmissions and msg4 initial transmissions and retransmissions, after a direct msg3 208 transmission in CG. In some aspects, similar to RA-RNTI 402, the CG-RNTI 404 may be determined based at least in part on the parameters of the used CG occasion, which can be defined as an associated time/frequency resource and/or DMRS sequence/port range within that time/frequency resource. For example, the above parameters may include the time/frequency location and the DMRS sequence(s) of the used CG occasion, including slot index, symbol index in the containing slot, frequency occasion index, UL carrier index (normal uplink (NUL) or supplementary uplink (SUL)), the DMRS scrambling ID, and the number of DMRS ports.

In the case where multiple CG occasions are selected for repetition or frequency hopping, the CG-RNTI 404 may be determined based at least in part on one of the used CG occasions (e.g., the first or last CG occasion), where the order index per CG occasion is determined based at least in part on its time resource order index, frequency resource order index, and/or DMRS sequence/port range order index within that time/frequency resource, similar to the RO order index determination.

In some aspects, the FWA UE 220 may determine the CG-RNTI by the UE contention resolution ID carried in msg3 208. For example, the FWA UE 220 may consider the X most significant bits (MSBs) or least significant bits (LSBs) of the UE contention resolution ID or a certain hash function output of the ID.

In some aspects associated with CG-based initial access, a TC-RNTI 406 (or C-RNTI) may be carried in msg4 212 and may become C-RNTI for the FWA UE 220 with contention resolved as indicated in msg4 212.

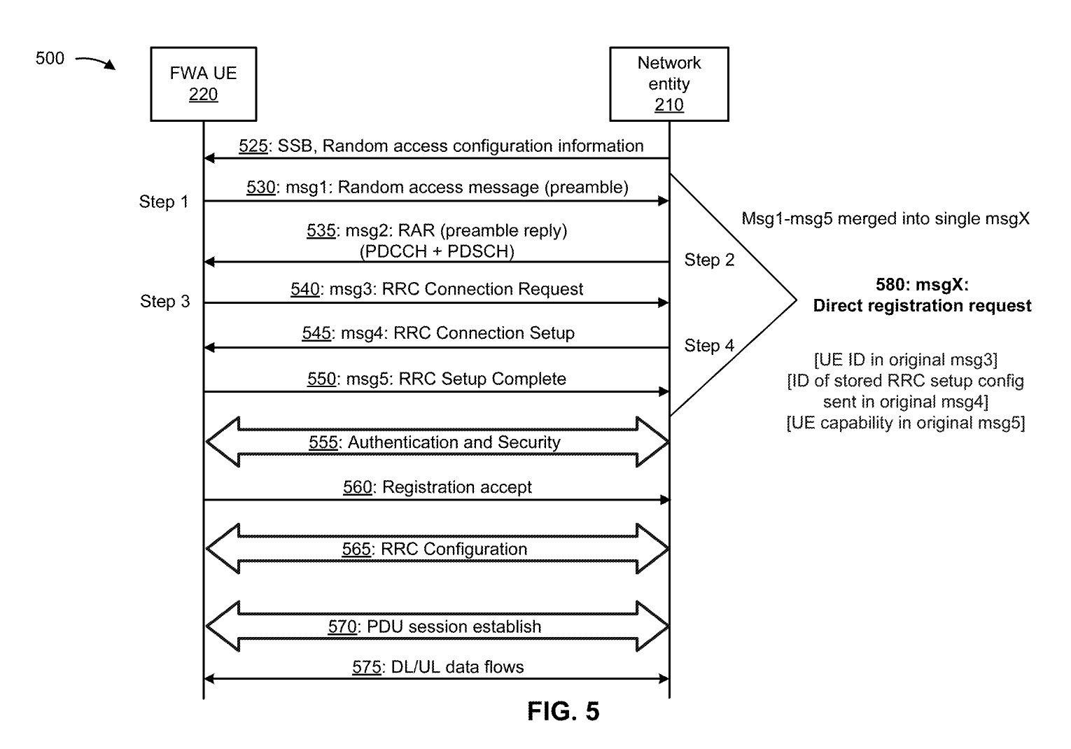

FIG. 5 is a diagram illustrating an example 500 of an access procedure that skips messages.

As shown by reference number 525, the network entity 210 may transmit, and the FWA UE 220 may receive, one or more SSBs and random access configuration information. The random access configuration information may include one or more parameters to be used in the random access procedure, such as one or more parameters for transmitting a RACH message (RAM) or one or more parameters for receiving a RAR.

As shown by reference number 530, the FWA UE 220 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step RACH procedure. The random access message may include a random access preamble identifier.

As shown by reference number 535, the network entity 210 may transmit an RAR as a reply to the preamble. The message that includes the RAR may be referred to as message 2, msg2, MSG2, or a second message in a four-step RACH procedure. In some aspects, the RAR may indicate the detected random access preamble identifier (e.g., received from the FWA UE 220 in msg1). Additionally, or alternatively, the RAR may indicate a resource allocation to be used by the UE 220 to transmit message 3 (msg3).

In some aspects, as part of the second step of the four-step RACH procedure, the network entity 210 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step RACH procedure, the network entity 210 may transmit the PDSCH communication for the RAR, as scheduled by the PDCCH communication. The RAR may be included in a MAC protocol data unit (PDU) of the PDSCH communication.

As shown by reference number 540, the FWA UE 220 may transmit an RRC connection request message. The RRC connection request message may be referred to as message 3, msg3, MSG3, or a third message of a four-step RACH procedure. In some aspects, the RRC connection request may include a UE identifier, UCI, or a PUSCH communication (e.g., an RRC connection request).

As shown by reference number 545, the network entity 210 may transmit an RRC connection setup message. The RRC connection setup message may be referred to as message 4, msg4, MSG4, or a fourth message of a four-step RACH procedure. In some aspects, the RRC connection setup message may include the detected UE identifier, a timing advance value, or contention resolution information. If the FWA UE 220 successfully receives the RRC connection setup message, the FWA UE 220 may transmit a HARQ ACK for the msg4.

As shown by reference number 550, the network entity 210 may transmit a msg5 for an RRC setup complete message. As shown by reference number 555, the FWA UE 220 may proceed with authentication and security. As shown by reference number 560, the FWA UE 220 may complete registration.

As shown by reference number 565, the network entity 210 may transmit an RRC reconfiguration. As shown by reference number 570, a PDU session is established. As shown by reference number 575, the DL and UL data flows may proceed.

In the context of RACH-based initial access for RRC establishment from an idle UE the RRC setup process typically involves three messages: msg3, msg4, and msg5. Msg3 includes the RRC setup request, which contains at least part of the UE's identifier. Msg4 contains the RRC setup configuration, which provides the radio bearer configuration and the master cell group (MCG) configuration (typically only the primary cell) for the setup of signaling radio bearer 1 (SRB1) with the central unit (CU), comprising around 1000 bits. Msg5 confirms the completion of the RRC setup and provides additional UE information, such as the remaining UE identifier, UE capabilities, available reports, the registered access and mobility management function (AMF) identifier, and the registration request, which triggers the subsequent authentication and security process with the core network.

However, for FWA UEs, the RRC setup configuration in msg4 may remain unchanged for extended periods. Therefore, msg4 can be skipped by storing the configuration at the UE. Additionally, msg3 and msg5 can be merged into a single message that includes a direct registration request to the core network, streamlining the process and reducing signaling overhead.

In some aspects of an RRC setup procedure, msg3 to msg5 can be consolidated into a single message, referred to as msgX and shown by 580, to facilitate direct core network registration, particularly for FWA UEs. This optimization can be achieved by leveraging the known TA information, allowing msg1 and msg2 to be omitted. The RRC setup configuration typically contained in msg4 can be stored by the UE, enabling the merging of msg3 and msg5 into msgX. That is, msg4 can be skipped (the RRC setup message in msg4 would be the same for a CPE device staying in the same cell). The single message, msgX, may not only serve as a direct registration request to the core network but also include the identifier of the stored RRC setup configuration, streamlining the registration process and reducing signaling overhead. msgX may also contain the ID of the stored RRC setup configuration.

In some aspects, the msgX for direct core network registration request for an idle FWA UE transitioning to connected mode may include several key pieces of information. Firstly, msgX may include the UE ID, such as a 5G-S-TMSI-part1, which is typically carried in msg3. Additionally, it includes the ID for the stored RRC setup configuration, which is usually found in msg4 and is used to set up the SRB1 with the CU. This RRC setup configuration generally comprises the radio bearer configuration and the MCG configuration, typically only for the PCell. Furthermore, msgX encompasses the core network registration request, which is commonly part of msg5 and triggers subsequent authentication, security, and RRC reconfiguration processes. This registration request typically includes the UE's capabilities and the registered AMF ID, along with any dynamic information from the FWA UE 220, such as a measurement report availability indicator, which is also usually carried in msg5.

Upon receiving msgX, the network entity 210 may load the corresponding stored RRC setup configuration. In the next downlink message, the network entity 210 may acknowledge the completion of the RRC setup and initiate the subsequent procedures. This streamlined process helps to efficiently transition the idle FWA UE to a connected mode, ensuring that all necessary configurations and registrations are promptly and accurately handled.

In some aspects, the direct registration request may be enabled through two main options. In the first option, the network entity 210 may unicast the enablement command along with the RRC setup-related configuration for the FWA UE 220 to store and the corresponding configuration ID. This can be done via dedicated RRC, MAC-CE, or DCI during a previous connection, such as during RRC release or suspend. The FWA UE 220 may then use this stored configuration for future RRC setup procedures. In the second option, the network entity 210 broadcasts the enablement command, the RRC setup-related configuration, and the corresponding configuration ID for applicable types of UEs, such as FWA UEs. These UEs can be identified by their capabilities or subscription information from the FWA UE 220 to the core network. The FWA UE 220 may then use the broadcast configuration for future RRC setup procedures.

Once enabled, if the TA is known, the FWA UE 220 may trigger a direct msgX with CG-based access. If the TA is unknown, the FWA UE 220 may fall back to RACH-based access using the original msg1-5 sequence or a simplified RACH-based access with msg1-2 followed by msgX, skipping msg3 and msg4. Additionally, the network or specifications should indicate for which cells the stored RRC setup configuration is valid, such as the enabling cell. To access other cells, the FWA UE 220 may need to send the msg3 to request the configuration in msg4 instead of sending msgX.

In some aspects, the direct registration request may also be disabled via dedicated or broadcast RRC, MAC-CE, or DCI for the intended UE or UE types. Once disabled, if the TA is known, the FWA UE 220 can trigger a direct msg3 with CG-based access. If the TA is unknown, the FWA UE 220 may revert to the original RACH-based access sequence with msg1-5.

Skipping msg1 and msg2 if TA is known can be applied to many use cases, in addition to initial access. For example, in small data transmission (SDT), the FWA UE 220 may transmit a few packets every hundreds of milliseconds. Skipping Msg1 and msg2 can reduce latency to those infrequent small packets. In addition, skipping msg1 and 2 can reduce the latency for RACH in connected mode, such as for RACH-based beam failure recovery (BFR), RACH based SR, and RACH based event triggered report.

As indicated above, FIG. 5 is provided as an example. Other examples may differ from what is described with regard to FIG. 5.

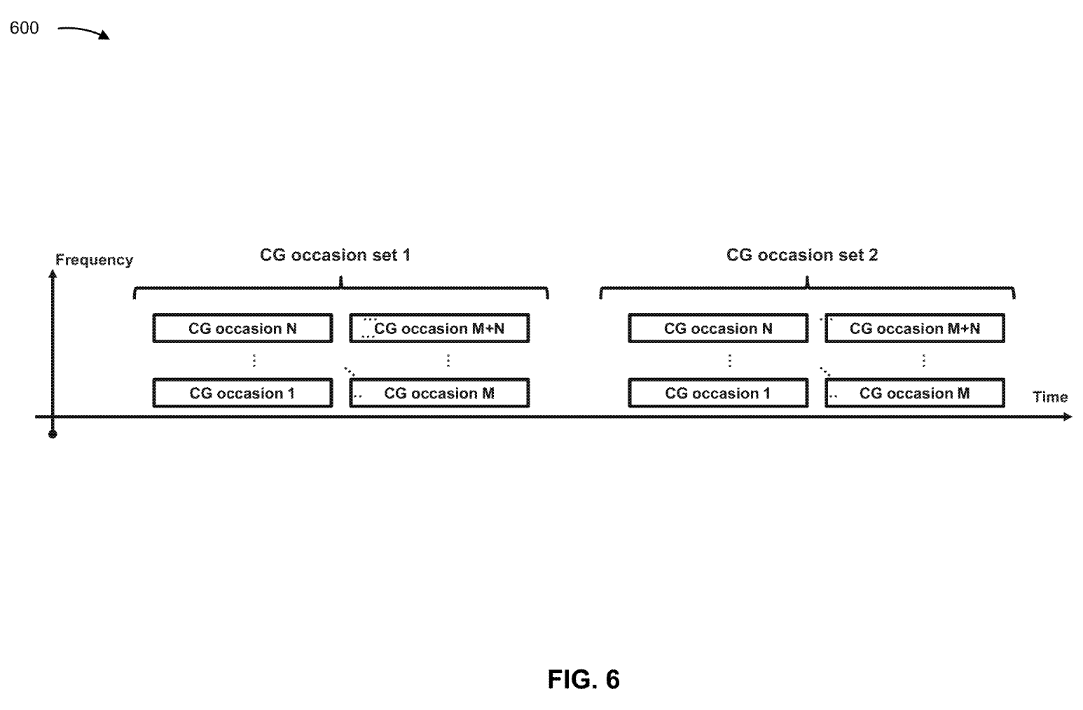

FIG. 6 is a diagram illustrating an example 600 of CG resources.

In some aspects, for CG-based access, a CG configuration may be specific to a particular UE type, which at least includes FWA UEs and non-FWA UEs. The CG-based access is applicable when TA is known, and at least includes RRC setup for idle UE, RRC resume for inactive UE transitioning to RRC connected mode, an SDT for UE staying in inactive mode, beam failure detection (BFD)/radio link failure (RLF) for connected UE failure recovery, a scheduling request, a buffer status report, event triggered report (e.g., for beam/cell report).

The UE type can be determined based on definition in a specification, indication from UE to RAN (e.g., UAI, UE capability, or subscription info from UE to core network). The UE-type specific CG configuration can be provided via dedicated RRC message or broadcast message (e.g., master information block (MIB), SIB, where UE selects the CG config corresponding to its type).

Example 600 shows CG resources. In some aspects, an allocated CG resource can be tailored specifically to a particular UE type or shared among multiple UE types. When CG resources are shared, the UE-type-specific CG configuration may include parameters that differentiate access priorities across different UE types. These parameters may include the CG resource selection probability for a given set of CG resources or occasions, the maximum number of selected CG resources or occasions among the total reserved ones in terms of time, frequency, and space, and the range of a random selection backoff counter that is activated once heavy collision is detected. For example, a UE can start selecting CG sets after the network signals to back off, with the selection being randomly chosen within a range specific to the UE type.

For CG-based access, the CG configuration can be specific to a particular UE, including FWA UEs. A network entity may provide a UE-specific CG configuration via a previous connection, and the UE may store the configuration for future CG-based access to the same cell or set of cells. The applicable cells can be indicated, and the configuration can be provided through a dedicated RRC message during the connection, or during RRC release or suspension. This customized CG configuration ensures necessary performance based on the FWA UE’s radio condition, addressing aspects such as reliability, access priority, spectrum efficiency, and traffic latency.

The UE-specific CG configuration may be validated through various conditions. If not validated, the UE may revert to a default CG configuration, which could be either UE-type-specific or non-UE-type-specific as indicated in a broadcast message. Validation options include the expiration of an associated timer that starts once the configuration is provided, detection of significant changes in the UE’s environment (such as cell quality, location, orientation, or timing), or an indication from paging or a low power wake-up signal (LP-WUS) on whether the UE-specific CG configuration is still valid.

In some aspects, the CG configuration, whether UE-type-specific or UE-specific, may include several parameters. These parameters cover aspects such as receiving the response for the CG transmission, setting the CG transmit power, determining the CG frequency and time resources, CG MIMO transmissions, CG configuration validity, MAC-layer operations, and additional uplink control information. For example, parameters for receiving the response for the CG transmission might include search space, control resource set (CORESET), RNTI, PDCCH repetition configuration, and DMRS power boost. Parameters for setting the CG transmit power could involve P0, alpha, path loss reference signal, closed-loop index, and power ramping step size for retransmissions. Additionally, parameters for determining CG frequency and time resources might include reference frequency, UL BWP, frequency hopping offset, and the periodicity and offset for periodically transmitted CG occasion sets.

Cell periodically broadcasts CG resources for contention-based access for UEs with known a TA, where there are total M+N CG occasions allocated periodically for UEs to perform random access in every period. The assumed baseline is based on a random access track. If CPE devices with known TA try to reuse the same set of CG occasions for random access, the network entity 210 can assign more aggressive access parameters for CPE devices (e.g., higher probability to select a CG occasion), and multiple CG occasions can be selected, since CPE devices typically pay a higher subscription/service fee.

If a CPE device is really important (e.g., VIP level of service), the network entity 210 may allocate a dedicated CG resource for this CPE device’s random access. The CG resource has transmit parameters optimized based on the CPE device’s channel condition to ensure most efficient operation (e.g., # of repetitions, number of MIMO layers).

As indicated above, FIG. 6 is provided as an example. Other examples may differ from what is described with regard to FIG. 6.

FIG. 7 is a diagram illustrating an example process 700 performed, for example, at an FWA UE or an apparatus of an FWA UE. Example process 700 is an example where the apparatus or the FWA UE (e.g., FWA UE 220) performs operations associated with enhanced access for FWA UEs.

As shown in FIG. 7, in some aspects, process 700 may include transmitting, using stored TA information, a msg3 associated with CG-based access after a msg1 and a msg2 is skipped (block 710). For example, the FWA UE (e.g., using transmission component 904 or communication manager 906, depicted in FIG. 9) may transmit, using stored TA information, a msg3 associated with CG-based access after a msg1 and a msg2 is skipped, as described above.

As further shown in FIG. 7, in some aspects, process 700 may include receiving a message in response to the msg3 (block 720). For example, the FWA UE (e.g., using reception component 902 or communication manager 906, depicted in FIG. 9) may receive a message in response to the msg3, as described above.

Process 700 may include additional aspects, such as any single aspect or any combination of aspects described below or in connection with one or more other processes described elsewhere herein.

In a first aspect, process 700 includes determining whether to use a timer-based TA update scheme or an environment-based TA update scheme for a cell based on long-term mobility type information of the FWA UE.

In a second aspect, alone or in combination with the first aspect, process 700 includes receiving a configuration for the timer-based TA update scheme and a configuration for the environment-based TA update scheme.

In a third aspect, alone or in combination with one or more of the first and second aspects, process 700 includes determining whether to use a timer-based TA update scheme or an environment-based TA update scheme based on a cell switch count.

In a fourth aspect, alone or in combination with one or more of the first through third aspects, process 700 includes detecting an environmental change associated with the FWA UE based on at least one of a signal measurement, a location of the FWA UE, an orientation of the FWA UE, or a downlink timing, and initiating a TA update using a TA update scheme for the FWA UE in response to the detected environmental change.

In a fifth aspect, alone or in combination with one or more of the first through fourth aspects, initiating a TA update includes initiating the TA update based at least in part on the detected environmental change satisfying a predefined threshold.

In a sixth aspect, alone or in combination with one or more of the first through fifth aspects, detecting the environmental change includes detecting a variation in cell quality measurements for a set of measured cells or cell pairs over a predefined time period.

In a seventh aspect, alone or in combination with one or more of the first through sixth aspects, detecting the environmental change includes detecting a variation in a location or orientation that satisfies a threshold over a predefined time period.

In an eighth aspect, alone or in combination with one or more of the first through seventh aspects, process 700 includes calculating an updated TA based at least in part on a received timing difference between a first cell and a reference cell and a known TA value for the reference cell.

In a ninth aspect, alone or in combination with one or more of the first through eighth aspects, process 700 includes receiving an indication of a TA update scheme.

In a tenth aspect, alone or in combination with one or more of the first through ninth aspects, process 700 includes starting a timer after completion of the TA update, wherein updated TA is valid until the timer expires.

In an eleventh aspect, alone or in combination with one or more of the first through tenth aspects, process 700 includes receiving one or more conditions that forbid the FWA UE from initiating a new TA update for a specified duration.

In a twelfth aspect, alone or in combination with one or more of the first through eleventh aspects, the FWA UE is preconfigured with a TA validity condition that determines when an updated TA remains valid based on a recurrence of one or more configured events.

In a thirteenth aspect, alone or in combination with one or more of the first through twelfth aspects, process 700 includes receiving a message with a CG radio network temporary identifier for scheduling a msg3 retransmission associated with skipping the msg1 and the msg2.

In a fourteenth aspect, alone or in combination with one or more of the first through thirteenth aspects, process 700 includes transmitting a direct registration request message independent of receiving a previous message with TA information.

In a fifteenth aspect, alone or in combination with one or more of the first through fourteenth aspects, the msg3 or a combination message for the msg3 and a msg5 includes a direct registration request associated with skipping the msg1 and the msg2.

In a sixteenth aspect, alone or in combination with one or more of the first through fifteenth aspects, process 700 includes receiving an indication to enable or disable use of the direct registration request.

In a seventeenth aspect, alone or in combination with one or more of the first through sixteenth aspects, the CG-based access is associated with initial access, RRC setup for an idle UE, RRC resume for an inactive UE transitioning to RRC connected mode, a small data transmission for UE staying in inactive mode, beam failure detection or radio link failure for a connected UE failure recovery, a scheduling request, a buffer status report, or an event triggered report.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a UE or an apparatus of a UE. Example process 800 is an example where the apparatus or the UE (e.g., UE 120, FWA UE 220) performs operations associated with enhanced access for FWA UEs.

As shown in FIG. 8, in some aspects, process 800 may include receiving a configuration for a CG-based access that is specific to an FWA UE or a non-FWA UE (block 810). For example, the UE (e.g., using reception component 902 or communication manager 906, depicted in FIG. 9) may receive a configuration for a CG-based access that is specific to an FWA UE or a non-FWA UE, as described above.

As further shown in FIG. 8, in some aspects, process 800 may include transmitting, using stored TA information, a msg3 associated with the CG-based access after a msg1 and a msg2 is skipped (block 820). For example, the UE (e.g., using transmission component 904 or communication manager 906, depicted in FIG. 9) may transmit, using stored TA information, a msg3 associated with the CG-based access after a msg1 and a msg2 is skipped, as described above.

Process 800 may include additional aspects, such as any single aspect or any combination of aspects described below or in connection with one or more other processes described elsewhere herein.

In a first aspect, the configuration is specific to the UE.

In a second aspect, alone or in combination with the first aspect, the configuration includes parameters for receiving a response for a CG-based transmission, setting a CG transmit power, determining a CG frequency resource, determining a CG time resource, determining a CG multiple-input-multiple-output transmissions, determining a CG configuration validity, related to medium access control layer operation, or additional uplink control.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 1-6. Additionally, or alternatively, the apparatus 900 may be configured to perform one or more processes described herein, such as process 700 of FIG. 7, process 800 of FIG. 8, or a combination thereof. In some aspects, the apparatus 900 or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

In some aspects, the transmission component 904 may transmit, using stored TA information, a msg3 associated with CG-based access after a msg1 and a msg2 is skipped. The reception component 902 may receive a message in response to the msg3.

The communication manager 906 may determine whether to use a timer-based TA update scheme or an environment-based TA update scheme for a cell based on long-term mobility type information of the FWA UE. The reception component 902 may receive a configuration for the timer-based TA update scheme and a configuration for the environment-based TA update scheme. The communication manager 906 may determine whether to use a timer-based TA update scheme or an environment-based TA update scheme based on a cell switch count.

The communication manager 906 may detect an environmental change associated with the FWA UE based on at least one of a signal measurement, a location of the FWA UE, an orientation of the FWA UE, or a downlink timing. The communication manager 906 may initiate a TA update using a TA update scheme for the FWA UE in response to the detected environmental change.

The communication manager 906 may calculate an updated TA based at least in part on a received timing difference between a first cell and a reference cell and a known TA value for the reference cell. The reception component 902 may receive an indication of a TA update scheme. The communication manager 906 may start a timer after completion of the TA update, wherein updated TA is valid until the timer expires.

The reception component 902 may receive one or more conditions that forbid the FWA UE from initiating a new TA update for a specified duration. The reception component 902 may receive a message with a CG radio network temporary identifier for scheduling a msg3 retransmission associated with skipping the msg1 and the msg2.

The transmission component 904 may transmit a direct registration request message independent of receiving a previous message with TA information. The reception component 902 may receive an indication to enable or disable use of the direct registration request.

In some aspects, the reception component 902 may receive a configuration for a CG-based access that is specific to an FWA UE or a non-FWA UE. The transmission component 904 may transmit, using TA information, a msg3 associated with the CG-based access after a msg1 and a msg2 is skipped.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

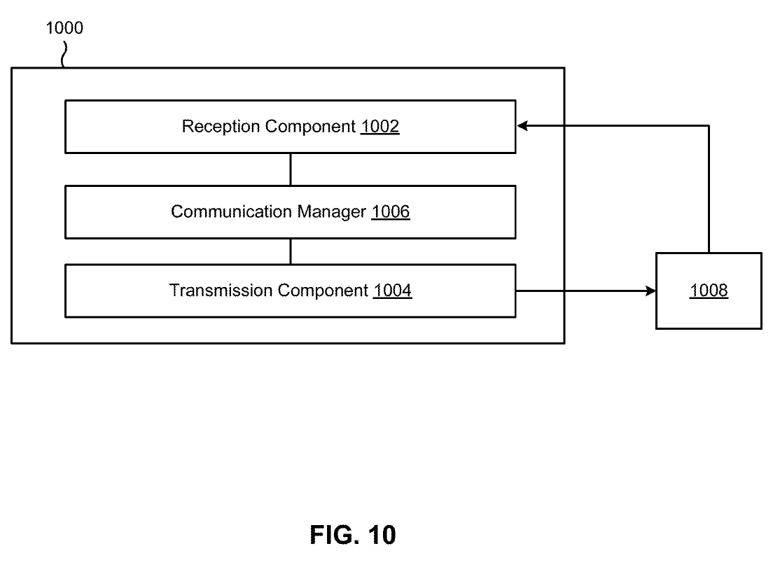

FIG. 10 is a diagram of an example apparatus 1000 for wireless communication. The apparatus 1000 may be a network entity, or a network entity may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network entity.

In some aspects, the apparatus 1000 may be configured to perform one or more operations described herein in connection with FIGS. 1-6. Additionally, or alternatively, the apparatus 1000 may be configured to perform one or more processes that mirror the processes described herein. In some aspects, the apparatus 1000 or one or more components shown in FIG. 10 may include one or more components of the network entity described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network entity described above in connection with FIG. 1, such as a radio, one or more RF chains, one or more transceivers, or one or more modems, each of which may in turn be coupled with one or more antennas of the network entity.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network entity described above in connection with FIG. 1, such as a radio, one or more RF chains, one or more transceivers, or one or more modems, each of which may in turn be coupled with one or more antennas of the network entity described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

In some aspects, the reception component 1002 may receive a msg3 associated with CG-based access after a msg1 and a msg2 is skipped. The transmission component 904 may transmit a message in response to the msg3.

The communication manager 1006 may determine whether to use a timer-based TA update scheme or an environment-based TA update scheme for a cell based on long-term mobility type information of the FWA UE. The reception component 1002 may receive a configuration for the timer-based TA update scheme and a configuration for the environment-based TA update scheme. The communication manager 1006 may determine whether to use a timer-based TA update scheme or an environment-based TA update scheme based on a cell switch count.

The communication manager 1006 may detect an environmental change associated with the FWA UE based on at least one of a signal measurement, a location of the FWA UE, an orientation of the FWA UE, or a downlink timing. The communication manager 1006 may initiate a TA update using a TA update scheme for the FWA UE in response to the detected environmental change.

The transmission component 1004 may transmit an indication of a TA update scheme. The communication manager 1006 may start a timer after completion of the TA update, where updated TA is valid until the timer expires.

The transmission component 1004 may transmit one or more conditions that forbid the FWA UE from initiating a new TA update for a specified duration. The transmission component 904 may transmit a message with a CG-RNTI for scheduling a msg3 retransmission associated with skipping the msg1 and the msg2.

The reception component 1002 may receive a direct registration request message independent of receiving a previous message with TA information. The transmission component 1004 may transmit an indication to enable or disable use of the direct registration request.

In some aspects, the transmission component 1004 may transmit a configuration for a CG-based access that is specific to an FWA UE or a non-FWA UE. The reception component 1002 may receive, using TA information, a msg3 associated with the CG-based access after a msg1 and a msg2 is skipped.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a fixed wireless access (FWA) user equipment (UE), comprising: transmitting, using stored timing advance (TA) information, a msg3 associated with configured grant (CG)-based access after a msg1 and a msg2 is skipped; and receiving a message in response to the msg3.

Aspect 2: The method of Aspect 1, further comprising determining whether to use a timer-based TA update scheme or an environment-based TA update scheme for a cell based on long-term mobility type information of the FWA UE.

Aspect 3: The method of Aspect 2, further comprising receiving a configuration for the timer-based TA update scheme and a configuration for the environment-based TA update scheme.

Aspect 4: The method of any of Aspects 1-3, further comprising determining whether to use a timer-based TA update scheme or an environment-based TA update scheme based on a cell switch count.

Aspect 5: The method of any of Aspects 1-4, further comprising: detecting an environmental change associated with the FWA UE based on at least one of a signal measurement, a location of the FWA UE, an orientation of the FWA UE, or a downlink timing; and initiating a TA update using a TA update scheme for the FWA UE in response to the detected environmental change.

Aspect 6: The method of Aspect 5, wherein initiating a TA update includes initiating the TA update based at least in part on the detected environmental change satisfying a predefined threshold.

Aspect 7: The method of Aspect 5, wherein detecting the environmental change includes detecting a variation in cell quality measurements for a set of measured cells or cell pairs over a predefined time period.

Aspect 8: The method of Aspect 5, wherein detecting the environmental change includes detecting a variation in a location or orientation that satisfies a threshold over a predefined time period.

Aspect 9: The method of any of Aspects 1-8, further comprising calculating an updated TA based at least in part on a received timing difference between a first cell and a reference cell and a known TA value for the reference cell.

Aspect 10: The method of any of Aspects 1-9, further comprising receiving an indication of a TA update scheme.

Aspect 11: The method of any of Aspects 1-10, further comprising starting a timer after completion of the TA update, wherein updated TA is valid until the timer expires.

Aspect 12: The method of any of Aspects 1-11, further comprising receiving one or more conditions that forbid the FWA UE from initiating a new TA update for a specified duration.

Aspect 13: The method of any of Aspects 1-12, wherein the FWA UE is preconfigured with a TA validity condition that determines when an updated TA remains valid based on a recurrence of one or more configured events.

Aspect 14: The method of any of Aspects 1-13, further comprising receiving a message with a CG radio network temporary identifier for scheduling a msg3 retransmission associated with skipping the msg1 and the msg2.

Aspect 15: The method of any of Aspects 1-14, further comprising transmitting a direct registration request message independent of receiving a previous message with TA information.

Aspect 16: The method of any of Aspects 1-15, wherein the msg3 or a combination message for the msg3 and a msg5 includes a direct registration request associated with skipping the msg1 and the msg2.

Aspect 17: The method of Aspect 16, further comprising receiving an indication to enable or disable use of the direct registration request.

Aspect 18: The method of any of Aspects 1-17, wherein the CG-based access is associated with initial access, radio resource control (RRC) setup for an idle UE, RRC resume for an inactive UE transitioning to RRC connected mode, a small data transmission for UE staying in inactive mode, beam failure detection or radio link failure for a connected UE failure recovery, a scheduling request, a buffer status report, or an event triggered report.

Aspect 19: A method of wireless communication performed by a user equipment (UE), comprising: receiving a configuration for a configured grant (CG)-based access that is specific to a fixed wireless access (FWA) UE or a non-FWA UE; and transmitting, using stored timing advance (TA) information, a msg3 associated with the CG-based access after a msg1 and a msg2 is skipped.

Aspect 20: The method of Aspect 19, wherein the configuration is specific to the UE.

Aspect 21: The method of any of Aspects 19-20, wherein the configuration includes parameters for receiving a response for a CG-based transmission, setting a CG transmit power, determining a CG frequency resource, determining a CG time resource, determining a CG multiple-input-multiple-output transmissions, determining a CG configuration validity, related to medium access control layer operation, or additional uplink control.

Aspect 22: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-21.

Aspect 23: An apparatus for wireless communication at a device, the apparatus comprising one or more memories and one or more processors coupled to the one or more memories, the one or more processors configured to cause the device to perform the method of one or more of Aspects 1-21.

Aspect 24: An apparatus for wireless communication, the apparatus comprising at least one means for performing the method of one or more of Aspects 1-21.

Aspect 25: A non-transitory computer-readable medium storing code for wireless communication, the code comprising instructions executable by one or more processors to perform the method of one or more of Aspects 1-21.

Aspect 26: A non-transitory computer-readable medium storing a set of instructions for wireless communication, the set of instructions comprising one or more instructions that, when executed by one or more processors of a device, cause the device to perform the method of one or more of Aspects 1-21.

Aspect 27: A device for wireless communication, the device comprising a processing system that includes one or more processors and one or more memories coupled with the one or more processors, the processing system configured to cause the device to perform the method of one or more of Aspects 1-21.

Aspect 28: An apparatus for wireless communication at a device, the apparatus comprising one or more memories and one or more processors coupled to the one or more memories, the one or more processors individually or collectively configured to cause the device to perform the method of one or more of Aspects 1-21.

Aspect 29: A device comprising a processing system that includes one or more processors and one or more code-storing memories coupled with the one or more processors, the processing system configured to cause the device to perform the method of one or more of Aspects 1-21.

Aspect 30: A device comprising a processing system that includes processor circuitry and code-storing memory circuitry, the processing system configured to cause the device to perform the method of one or more of Aspects 1-21.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A fixed wireless access (FWA) user equipment (UE), comprising:
a processing system that includes one or more processors and one or more code-storing memories coupled with the one or more processors, the processing system configured to cause the FWA UE to:
transmit, using stored timing advance (TA) information, a msg3 associated with configured grant (CG)-based access after a msg1 and a msg2 is skipped; and
receive a message in response to the msg3.

2. The FWA UE of claim 1, wherein the processing system is configured to cause the FWA UE to determine whether to use a timer-based TA update scheme or an environment-based TA update scheme for a cell based on long-term mobility type information of the FWA UE.

3. The FWA UE of claim 2, wherein the processing system is configured to cause the FWA UE to receive a configuration for the timer-based TA update scheme and a configuration for the environment-based TA update scheme.

4. The FWA UE of claim 1, wherein the processing system is configured to cause the FWA UE to determine whether to use a timer-based TA update scheme or an environment-based TA update scheme based on a cell switch count.

5. The FWA UE of claim 1, wherein the processing system is configured to cause the FWA UE to:
detect an environmental change associated with the FWA UE based on at least one of a signal measurement, a location of the FWA UE, an orientation of the FWA UE, or a downlink timing; and
initiate a TA update using a TA update scheme for the FWA UE in response to the detected environmental change.

6. The FWA UE of claim 5, wherein to initiate a TA update, the one or more processors are configured to cause the FWA UE to initiate the TA update based at least in part on the detected environmental change satisfying a predefined threshold.

7. The FWA UE of claim 5, wherein to detect the environmental change, the one or more processors are configured to cause the FWA UE to detect a variation in cell quality measurements for a set of measured cells or cell pairs over a predefined time period or detect a variation in a location or an orientation that satisfies a threshold over a predefined time period.

8. The FWA UE of claim 1, wherein the processing system is configured to cause the FWA UE to calculate an updated TA based at least in part on a received timing difference between a first cell and a reference cell and a known TA value for the reference cell.

9. The FWA UE of claim 1, wherein the processing system is configured to cause the FWA UE to receive an indication of a TA update scheme.

10. The FWA UE of claim 1, wherein the processing system is configured to cause the FWA UE to start a timer after completion of the TA update, wherein updated TA is valid until the timer expires.

11. The FWA UE of claim 1, wherein the processing system is configured to cause the FWA UE to receive one or more conditions that forbid the FWA UE from initiating a new TA update for a specified duration.

12. The FWA UE of claim 1, wherein the FWA UE is preconfigured with a TA validity condition that determines when an updated TA remains valid based on a recurrence of one or more configured events.

13. The FWA UE of claim 1, wherein the processing system is configured to cause the FWA to receive a message with a CG radio network temporary identifier for scheduling a msg3 retransmission associated with skipping the msg1and the msg2.

14. The FWA UE of claim 1, wherein the processing system is configured to cause the FWA to transmit a direct registration request message independent of receiving a previous message with TA information.

15. The FWA UE of claim 1, wherein the msg3 or a combination message for the msg3 and a msg5 includes a direct registration request associated with skipping the msg1 and the msg2.

16. The FWA UE of claim 15, wherein the processing system is configured to cause the FWA to receive an indication to enable or disable use of the direct registration request.

17. The FWA UE of claim 1, wherein the CG-based access is associated with initial access, radio resource control (RRC) setup for an idle UE, RRC resume for an inactive UE transitioning to RRC connected mode, a small data transmission for UE staying in inactive mode, beam failure detection or radio link failure for a connected UE failure recovery, a scheduling request, a buffer status report, or an event triggered report.

18. A user equipment (UE), comprising:
a processing system that includes one or more processors and one or more code-storing memories coupled with the one or more processors, the processing system configured to cause the UE to:
receive a configuration for a configured grant (CG)-based access that is specific to a fixed wireless access (FWA) UE or a non-FWA UE; and
transmit, using stored timing advance (TA) information, a msg3 associated with the CG-based access after a msg1 and a msg2 is skipped.

19. The UE of claim 18, wherein the configuration is specific to the UE.

20. The UE of claim 18, wherein the configuration includes parameters for receiving a response for a CG-based transmission, setting a CG transmit power, determining a CG frequency resource, determining a CG time resource, determining a CG multiple-input-multiple-output transmissions, determining a CG configuration validity, related to medium access control layer operation, or additional uplink control.
